(19) United States
(12) Patent Application Publication
(10) Pub. No.: US 2020/0302369 A1
(43) Pub. Date: Sep. 24, 2020

(54) SYSTEMS AND METHOD FOR WORK ITEM SKILL DETERMINATION

(71) Applicant: ServiceNow, Inc., Santa Clara, CA (US)

(72) Inventors: Cong Tang, Fremont, CA (US); Brendan Joseph Ruchert-Dixon, San Jose, CA (US); Tian Ye, Santa Clara, CA (US); Yong Liang, Palo Alto, CA (US); Prithvi Yoganand, Dublin, CA (US)

(21) Appl. No.: 16/358,296

(22) Filed: Mar. 19, 2019

(51) Int. Cl. G06Q 10/06; G06Q 10/10

(52) U.S. Cl. CPC G06Q 10/063112; G06Q 10/1097; G06Q 10/063116

(57) ABSTRACT

Skill determination rules may be defined and applied to work items to identify the relevant skills associated with the work item. A skill determination rule definition graphical user interface (GUI) may be utilized to received date defining one or more skill determination rules. Once skill determination rules are defined, upon receipt of a work item, the relevant skill determination rules may be identified and applied to identify relevant skills associated with the work item. An agent possessing the identified skills may be identified and the work item added to the selected agent's queue.

### BACKGROUND

The present disclosure relates generally to providing customer service via agents, and more specifically to routing and assigning work items to agents.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Organizations, regardless of size, rely upon access to information technology (IT) and data and services for their continued operation and success. A respective organization's IT infrastructure may have associated hardware resources (e.g. computing devices, load balancers, firewalls, switches, etc.) and software resources (e.g. productivity software, database applications, custom applications, and so forth). Over time, more and more organizations have turned to cloud computing approaches to supplement or enhance their IT infrastructure solutions.

Cloud computing relates to the sharing of computing resources that are generally accessed via the Internet. In particular, a cloud computing infrastructure allows users, such as individuals and/or enterprises, to access a shared pool of computing resources, such as servers, storage devices, networks, applications, and/or other computing based services. By doing so, users are able to access computing resources on demand that are located at remote locations, which resources may be used to perform a variety of computing functions (e.g., storing and/or processing large quantities of computing data). For enterprise and other organization users, cloud computing provides flexibility in accessing cloud computing resources without accruing large up-front costs, such as purchasing expensive network equipment or investing large amounts of time in establishing a private network infrastructure. Instead, by utilizing cloud computing resources, users are able redirect their resources to focus on their enterprise's core functions.

In modern communication networks, examples of cloud computing services a user may utilize include so-called infrastructure as a service (IaaS), software as a service (SaaS), and platform as a service (PaaS) technologies. IaaS is a model in which providers abstract away the complexity of hardware infrastructure and provide rapid, simplified provisioning of virtual servers and storage, giving enterprises access to computing capacity on demand. In such an approach, however, a user may be left to install and maintain platform components and applications. SaaS is a delivery model that provides software as a service rather than an end product. Instead of utilizing a local network or individual software installations, software is typically licensed on a subscription basis, hosted on a remote machine, and accessed by client customers as needed. For example, users are generally able to access a variety of enterprise and/or information technology (IT)-related software via a web browser. PaaS acts as an extension of SaaS that goes beyond providing software services by offering customizability and expandability features to meet a user's needs. For example, PaaS can provide a cloud-based developmental platform for users to develop, modify, and/or customize applications and/or automating enterprise operations without maintaining network infrastructure and/or allocating computing resources normally associated with these functions.

A service provider may provide customer service to its customers via one or more teams of agents. Customers may provide communications to the service provider requesting that an agent perform a task or engage in an interaction, which may result in a work item. Typically, the work item is manually reviewed by a human reviewer. The reviewer predicts what actions may be involved in resolving or addressing the work item, considers the available service agents, and assigns the work item to a service agent. This process may be slow, tedious, time consuming, prone to errors, and expensive.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

The disclosed subject matter includes techniques for defining skill determination rules and then using the skill determination rules to identify skills associated with work items. Specifically, defining a skill determination rule may include receiving a request to create a new skill determination rule or edit an existing skill determination rule. A skill determination rule definition GUI may then be generated and displayed. A type of skill determination rule may be selected. A simple rule may identify skills associated with the work item based on an attribute of the work item. A lookup or dynamic rule may identify skills associated with the work item by referencing a lookup table and mapping a field of the lookup table to a field of a source table. An advanced rule may identify skills associated with the work item by running a script. Dependent upon the type of rule selected, the user may provide inputs defining a rule of the selected type. Once inputs are provided, one or more tables may be updated to include the new and/or updated rule.

Once skill determination rules are defined, upon receipt of a work item, the relevant skill determination rules may be identified and applied. If the relevant skill determination rule is a simple rule, the relevant skills may be identified based on an attribute of the work item. If the relevant skill determination rule is a lookup or dynamic rule, the relevant skills may be identified by referencing a lookup table and mapping a field of the lookup table to a field of a source table. If the relevant skill determination rule is an advanced rule, the relevant skills may be identified by running a script on the work item. Once the relevant skills are identified, a many-to-many (m2m) object may be generated associating the work item with the relevant skills. Agents possessing the identified skills may be identified. If multiple agents are identified, an agent may be selected and the work item added to the selected agent's queue.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a block diagram of an embodiment of a cloud architecture in which embodiments of the present disclosure may operate;

FIG. 2 is a schematic diagram of an embodiment of a multi-instance cloud architecture in which embodiments of the present disclosure may operate;

FIG. 3 is a block diagram of a computing device utilized in a computing system that may be present in FIG. 1 or 2, in accordance with aspects of the present disclosure;

FIG. 4 is a block diagram illustrating an embodiment in which a virtual server supports and enables the client instance, in accordance with aspects of the present disclosure;

FIG. 5 is a schematic illustrating an architecture for providing customer service via one or more groups of agents, in accordance with aspects of the present disclosure;

FIG. 6 is a flow chart of a process performed by a routing and assignment system of the architecture shown in FIG. 5, in accordance with aspects of the present disclosure;

FIG. 7 is illustrates an embodiment of a schema of tables used by the routing and assignment system for skill determination, in accordance with aspects of the present disclosure;

FIG. 8 is a screenshot of an embodiment of a simple rule definition graphical user interface (GUI) for defining a simple rule, in accordance with aspects of the present disclosure;

FIG. 9 is a screenshot of an embodiment of a lookup or dynamic rule definition GUI for defining a lookup or dynamic rule, in accordance with aspects of the present disclosure;

FIG. 10 is a screenshot of an embodiment of a lookup table for the lookup or dynamic rule of FIG. 9, in accordance with aspects of the present disclosure;

FIG. 11 is a screenshot of an embodiment of an advanced rule definition GUI for defining an advanced rule, in accordance with aspects of the present disclosure;

FIG. 12 is a schematic of a skill architecture for skill determination, in accordance with aspects of the present disclosure;

FIG. 13 is a flow chart of a process for defining one or more rules for skill determination of work items, in accordance with aspects of the present disclosure;

FIG. 14 is a flow chart of a process for receiving a work item and identifying the skills associated with the work item, in accordance with aspects of the present disclosure;

FIG. 15 illustrates an example of applying a simple VIP skill determination rule, in accordance with aspects of the present disclosure;

FIG. 16 is illustrates an example of applying a lookup product skill determination rule, in accordance with aspects of the present disclosure;

FIG. 17 illustrates an example of applying a lookup language skill determination rule, in accordance with aspects of the present disclosure; and

FIG. 18 is illustrates an example of applying an advanced language skill determination rule, in accordance with aspects of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As used herein, the term “computing system” refers to an electronic computing device such as, but not limited to, a single computer, virtual machine, virtual container, host, server, laptop, and/or mobile device, or to a plurality of electronic computing devices working together to perform the function described as being performed on or by the computing system. As used herein, the term “medium” refers to one or more non-transitory, computer-readable physical media that together store the contents described as being stored thereon. Embodiments may include non-volatile secondary storage, read-only memory (ROM), and/or random-access memory (RAM). As used herein, the term “application” refers to one or more computing modules, programs, processes, workloads, threads and/or a set of computing instructions executed by a computing system. Example embodiments of an application include software modules, software objects, software instances and/or other types of executable code.

A service provider may provide customer service via one or more teams of agents. Communications received from customers may trigger the creation of a work item. Typically, the work item is manually reviewed by a human reviewer, who predicts what actions may be involved in resolving or addressing the work item, considers the available service agents, and assigns the work item to a service agent. This process may be slow, tedious, time consuming, prone to errors, and expensive.

Accordingly, the disclosed techniques relate to defining skill determination rules and then using the skill determination rules to identify skills associated with work items. Upon receipt of a request to create a new skill determination rule or edit an existing skill determination rule, a skill determination rule definition GUI is generated and displayed and a type of skill determination rule may be selected. A simple rule may identify skills associated with the work item based on an attribute of the work item. A lookup or dynamic rule may identify skills associated with the work item by referencing a lookup table and mapping a field of the lookup table to a field of a source table. An advanced rule may identify skills associated with the work item by running a script. Dependent upon the type of rule selected, the user may provide inputs defining a rule of the selected type.

Once skill determination rules are defined, upon receipt of a work item, the relevant skill determination rules may be identified and applied. If the relevant skill determination rule is a simple rule, the relevant skills may be identified based on an attribute of the work item. If the relevant skill determination rule is a lookup or dynamic rule, the relevant skills may be identified by referencing a lookup table and mapping a field of the lookup table to a field of a source table. If the relevant skill determination rule is an advanced rule, the relevant skills may be identified by running a script on the work item. Once the relevant skills are identified, a many-to-many (m2m) object may be generated associating the work item with the relevant skills. Agents possessing the identified skills may be identified. If multiple agents are identified, an agent may be selected and the work item added to the selected agent's queue.

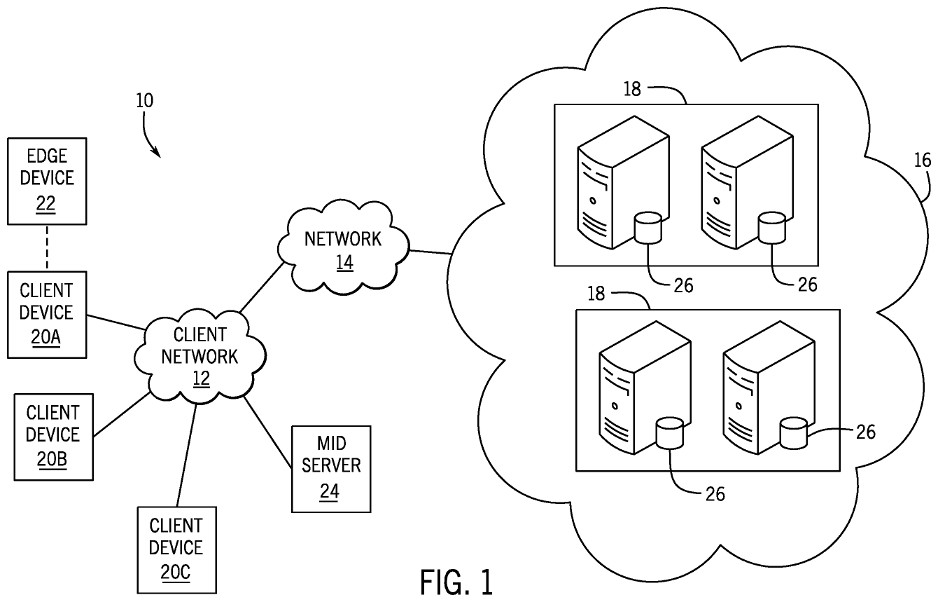

With the preceding in mind, the following figures relate to various types of generalized system architectures or configurations that may be employed to provide services to an organization in a multi-instance framework and on which the present approaches may be employed. Correspondingly, these system and platform examples may also relate to systems and platforms on which the techniques discussed herein may be implemented or otherwise utilized. Turning now to FIG. 1, a schematic diagram of an embodiment of a cloud computing system 10 where embodiments of the present disclosure may operate, is illustrated. The cloud computing system 10 may include a client network 12, a network 14 (e.g., the Internet), and a cloud-based platform 16. In some implementations, the cloud-based platform 16 may be a configuration management database (CMDB) platform. In one embodiment, the client network 12 may be a local private network, such as local area network (LAN) having a variety of network devices that include, but are not limited to, switches, servers, and routers. In another embodiment, the client network 12 represents an enterprise network that could include one or more LANs, virtual networks, data centers 18, and/or other remote networks. As shown in FIG. 1, the client network 12 is able to connect to one or more client devices 20A, 20B, and 20C so that the client devices are able to communicate with each other and/or with the network hosting the platform 16. The client devices 20 may be computing systems and/or other types of computing devices generally referred to as Internet of Things (IoT) devices that access cloud computing services, for example, via a web browser application or via an edge device 22 that may act as a gateway between the client devices 20 and the platform 16. FIG. 1 also illustrates that the client network 12 includes an administration or managerial device or server, such as a management, instrumentation, and discovery (MID) server 24 that facilitates communication of data between the network hosting the platform 16, other external applications, data sources, and services, and the client network 12. Although not specifically illustrated in FIG. 1, the client network 12 may also include a connecting network device (e.g., a gateway or router) or a combination of devices that implement a customer firewall or intrusion protection system.

For the illustrated embodiment, FIG. 1 illustrates that client network 12 is coupled to a network 14. The network 14 may include one or more computing networks, such as other LANs, wide area networks (WAN), the Internet, and/or other remote networks, to transfer data between the client devices 20 and the network hosting the platform 16. Each of the computing networks within network 14 may contain wired and/or wireless programmable devices that operate in the electrical and/or optical domain. For example, network 14 may include wireless networks, such as cellular networks (e.g., Global System for Mobile Communications (GSM) based cellular network), IEEE 802.11 networks, and/or other suitable radio-based networks. The network 14 may also employ any number of network communication protocols, such as Transmission Control Protocol (TCP) and Internet Protocol (IP). Although not explicitly shown in FIG. 1, network 14 may include a variety of network devices, such as servers, routers, network switches, and/or other network hardware devices configured to transport data over the network 14.

In FIG. 1, the network hosting the platform 16 may be a remote network (e.g., a cloud network) that is able to communicate with the client devices 20 via the client network 12 and network 14. The network hosting the platform 16 provides additional computing resources to the client devices 20 and/or the client network 12. For example, by utilizing the network hosting the platform 16, users of the client devices 20 are able to build and execute applications for various enterprise, IT, and/or other organization-related functions. In one embodiment, the network hosting the platform 16 is implemented on the one or more data centers 18, where each data center could correspond to a different geographic location. Each of the data centers 18 includes a plurality of virtual servers 26 (also referred to herein as application nodes, application servers, virtual server instances, application instances, or application server instances), where each virtual server 26 can be implemented on a physical computing system, such as a single electronic computing device (e.g., a single physical hardware server) or across multiple-computing devices (e.g., multiple physical hardware servers). Examples of virtual servers 26 include, but are not limited to a web server (e.g., a unitary Apache installation), an application server (e.g., unitary JAVA Virtual Machine), and/or a database server (e.g., a unitary relational database management system (RDBMS) catalog).

To utilize computing resources within the platform 16, network operators may choose to configure the data centers 18 using a variety of computing infrastructures. In one embodiment, one or more of the data centers 18 are configured using a multi-tenant cloud architecture, such that one of the server instances 26 handles requests from and serves multiple customers. Data centers 18 with multi-tenant cloud architecture commingle and store data from multiple customers, where multiple customer instances are assigned to one of the virtual servers 26. In a multi-tenant cloud architecture, the particular virtual server 26 distinguishes between and segregates data and other information of the various customers. For example, a multi-tenant cloud architecture could assign a particular identifier for each customer in order to identify and segregate the data from each customer. Generally, implementing a multi-tenant cloud architecture may suffer from various drawbacks, such as a failure of a particular one of the server instances 26 causing outages for all customers allocated to the particular server instance.

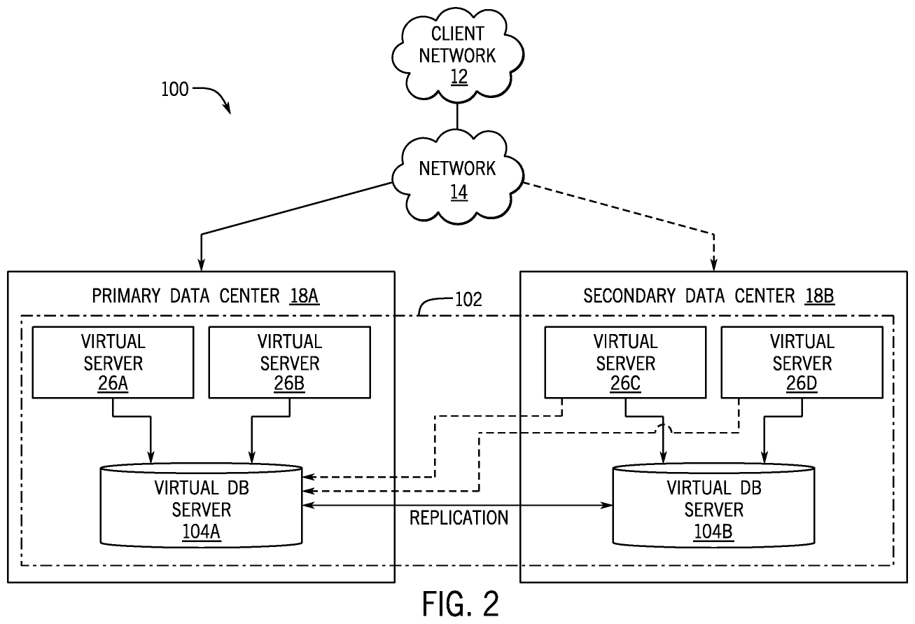

In another embodiment, one or more of the data centers 18 are configured using a multi-instance cloud architecture to provide every customer its own unique customer instance or instances. For example, a multi-instance cloud architecture could provide each customer instance with its own dedicated application server and dedicated database server. In other examples, the multi-instance cloud architecture could deploy a single physical or virtual server 26 and/or other combinations of physical and/or virtual servers 26, such as one or more dedicated web servers, one or more dedicated application servers, and one or more database servers, for each customer instance. In a multi-instance cloud architecture, multiple customer instances could be installed on one or more respective hardware servers, where each customer instance is allocated certain portions of the physical server resources, such as computing memory, storage, and processing power. By doing so, each customer instance has its own unique software stack that provides the benefit of data isolation, relatively less downtime for customers to access the platform 16, and customer-driven upgrade schedules. An example of implementing a customer instance within a multi-instance cloud architecture will be discussed in more detail below with reference to FIG. 2.

FIG. 2 is a schematic diagram of an embodiment of a multi-instance cloud architecture 100 where embodiments of the present disclosure may operate. FIG. 2 illustrates that the multi-instance cloud architecture 100 includes the client network 12 and the network 14 that connect to two (e.g., paired) data centers 18A and 18B that may be geographically separated from one another. Using FIG. 2 as an example, network environment and service provider cloud infrastructure client instance 102 (also referred to herein as a client instance 102) is associated with (e.g., supported and enabled by) dedicated virtual servers (e.g., virtual servers 26A, 26B, 26C, and 26D) and dedicated database servers (e.g., virtual database servers 104A and 104B). Stated another way, the virtual servers 26A-26D and virtual database servers 104A and 104B are not shared with other client instances and are specific to the respective client instance 102. In the depicted example, to facilitate availability of the client instance 102, the virtual servers 26A-26D and virtual database servers 104A and 104B are allocated to two different data centers 18A and 18B so that one of the data centers 18 acts as a backup data center. Other embodiments of the multi-instance cloud architecture 100 could include other types of dedicated virtual servers, such as a web server. For example, the client instance 102 could be associated with (e.g., supported and enabled by) the dedicated virtual servers 26A-26D, dedicated virtual database servers 104A and 104B, and additional dedicated virtual web servers (not shown in FIG. 2).

Although FIGS. 1 and 2 illustrate specific embodiments of a cloud computing system 10 and a multi-instance cloud architecture 100, respectively, the disclosure is not limited to the specific embodiments illustrated in FIGS. 1 and 2. For instance, although FIG. 1 illustrates that the platform 16 is implemented using data centers, other embodiments of the platform 16 are not limited to data centers and can utilize other types of remote network infrastructures. Moreover, other embodiments of the present disclosure may combine one or more different virtual servers into a single virtual server or, conversely, perform operations attributed to a single virtual server using multiple virtual servers. For instance, using FIG. 2 as an example, the virtual servers 26A, 26B, 26C, 26D and virtual database servers 104A, 104B may be combined into a single virtual server. Moreover, the present approaches may be implemented in other architectures or configurations, including, but not limited to, multi-tenant architectures, generalized client/server implementations, and/or even on a single physical processor-based device configured to perform some or all of the operations discussed herein. Similarly, though virtual servers or machines may be referenced to facilitate discussion of an implementation, physical servers may instead be employed as appropriate. The use and discussion of FIGS. 1 and 2 are only examples to facilitate ease of description and explanation and are not intended to limit the disclosure to the specific examples illustrated therein.

As may be appreciated, the respective architectures and frameworks discussed with respect to FIGS. 1 and 2 incorporate computing systems of various types (e.g., servers, workstations, client devices, laptops, tablet computers, cellular telephones, and so forth) throughout. For the sake of completeness, a brief, high level overview of components typically found in such systems is provided. As may be appreciated, the present overview is intended to merely provide a high-level, generalized view of components typical in such computing systems and should not be viewed as limiting in terms of components discussed or omitted from discussion.

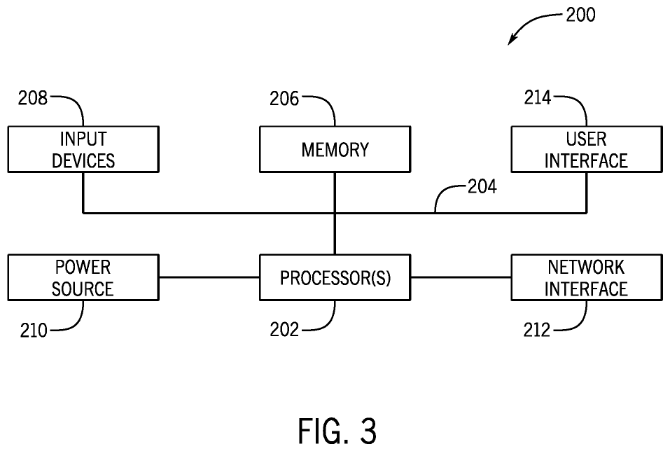

By way of background, it may be appreciated that the present approach may be implemented using one or more processor-based systems such as shown in FIG. 3. Likewise, applications and/or databases utilized in the present approach may be stored, employed, and/or maintained on such processor-based systems. As may be appreciated, such systems as shown in FIG. 3 may be present in a distributed computing environment, a networked environment, or other multi-computer platform or architecture. Likewise, systems such as that shown in FIG. 3, may be used in supporting or communicating with one or more virtual environments or computational instances on which the present approach may be implemented.

With this in mind, an example computer system may include some or all of the computer components depicted in FIG. 3. FIG. 3 generally illustrates a block diagram of example components of a computing system 200 and their potential interconnections or communication paths, such as along one or more busses. As illustrated, the computing system 200 may include various hardware components such as, but not limited to, one or more processors 202, one or more busses 204, memory 206, input devices 208, a power source 210, a network interface 212, a user interface 214, and/or other computer components useful in performing the functions described herein.

The one or more processors 202 may include one or more microprocessors capable of performing instructions stored in the memory 206. Additionally or alternatively, the one or more processors 202 may include application-specific integrated circuits (ASICs), field-programmable gate arrays (FPGAs), and/or other devices designed to perform some or all of the functions discussed herein without calling instructions from the memory 206.

With respect to other components, the one or more busses 204 include suitable electrical channels to provide data and/or power between the various components of the computing system 200. The memory 206 may include any tangible, non-transitory, and computer-readable storage media. Although shown as a single block in FIG. 1, the memory 206 can be implemented using multiple physical units of the same or different types in one or more physical locations. The input devices 208 correspond to structures to input data and/or commands to the one or more processors 202. For example, the input devices 208 may include a mouse, touchpad, touchscreen, keyboard and the like. The power source 210 can be any suitable source for power of the various components of the computing device 200, such as line power and/or a battery source. The network interface 212 includes one or more transceivers capable of communicating with other devices over one or more networks (e.g., a communication channel). The network interface 212 may provide a wired network interface or a wireless network interface. A user interface 214 may include a display that is configured to display text or images transferred to it from the one or more processors 202. In addition and/or alternative to the display, the user interface 214 may include other devices for interfacing with a user, such as lights (e.g., LEDs), speakers, and the like.

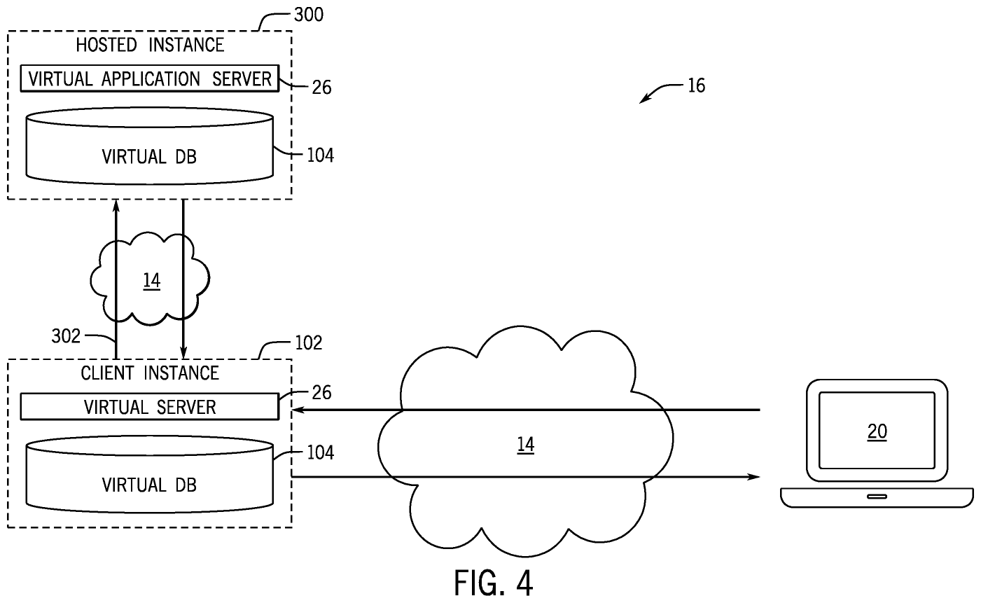

With the foregoing in mind, FIG. 4 is a block diagram illustrating an embodiment in which a virtual server 26 supports and enables the client instance 102, according to one or more disclosed embodiments. More specifically, FIG. 4 illustrates an example of a portion of a service provider cloud infrastructure, including the cloud-based platform 16 discussed above. The cloud-based platform 16 is connected to a client device 20 via the network 14 to provide a user interface to network applications executing within the client instance 102 (e.g., via a web browser of the client device 20). Client instance 102 is supported by virtual servers 26 similar to those explained with respect to FIG. 2, and is illustrated here to show support for the disclosed functionality described herein within the client instance 102. Cloud provider infrastructures are generally configured to support a plurality of end-user devices, such as client device 20, concurrently, wherein each end-user device is in communication with the single client instance 102. Also, cloud provider infrastructures may be configured to support any number of client instances, such as client instance 102, concurrently, with each of the instances in communication with one or more end-user devices. As mentioned above, an end-user may also interface with client instance 102 using an application that is executed within a web browser. The client instance 102 may also be configured to communicate with other instances, such as the hosted instance 300 shown in FIG. 4, which may also include a virtual application server 26 and a virtual database server 104.

For example, the hosted instance 300 may receive communications from the client instance 102 requesting help from a service agent. The communication may trigger creation of a work item that may represent a task to be completed by a service agent or an interaction to include the service agent. Because the work item may be associated with one or a few skills of a vast array of possible skills, it may be helpful to identify relevant skills associated with the work item and assign the work item to a service agent having the identified skills.

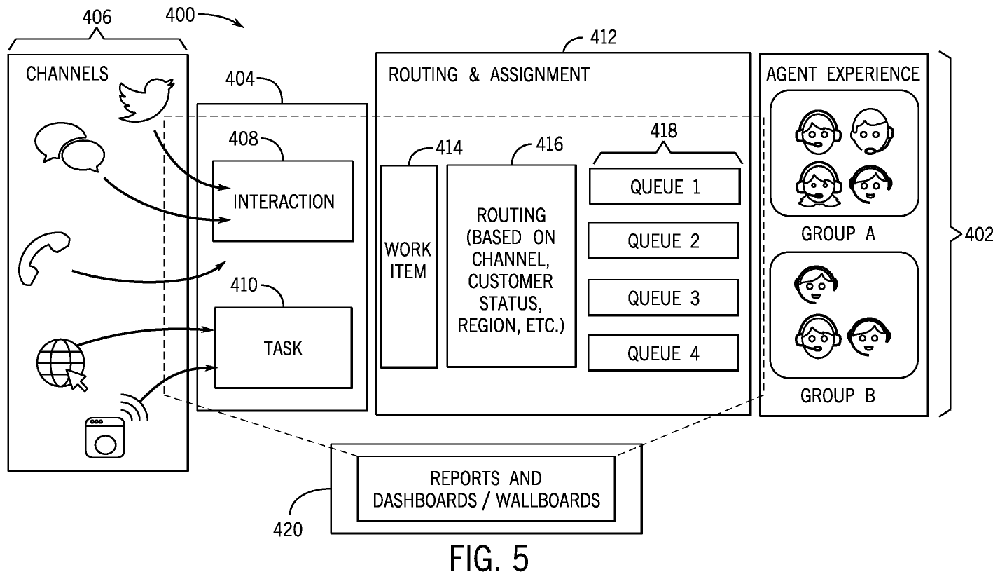

FIG. 5 is a schematic illustrating an architecture 400 for providing customer service via one or more groups of agents 402. As illustrated, communications 404 may be received via one or more channels 406. These channels 406 may include, for example, one or more social media platforms, telephone calls and/or voicemails, emails, text messages (e.g., SMS text messages), one or more websites, chat messages, etc. The communications 404 may include interactions 408 (e.g., a question to be answered) and/or tasks 410 (e.g., problem to be solved, diagnostic test to be performed, etc.). A task 410 may defined as a task or item to be addressed or performed by an agent. An interaction 408 may defined as a conversation request to be addressed by an agent. In some embodiments, a communication may include both an interaction 408 and a task 410.

Each communication 404 is provided to a routing and assignment system 412. Upon receipt of a communication 404, the routing and assignment system 412 generates a work item 414. It should be understood, however, that there may not be a one to one ratio in the number of communications 404 and the number of work items 414. For example, in some embodiments, a single communication 404 may result in multiple work items 414 (e.g., a received communication raises multiple issues). In other embodiments, multiple communications 404 may be combined into a single work item (e.g., multiple communications providing updates on a single problem being experienced). At block 416, each work item 414 is routed to a queue 418 of one or more capable agents 402. As is described in more detail below, routing a work item 414 to a queue 418 may include identifying what skills may be utilized to complete the work item 414, identifying an agent 402 that possesses those skills, and adding the work item to the agent's queue 418. Identifying what skills may be utilized to complete the work item 414 may include, for example, analyzing the text of the communication 404 (e.g., to identify products, services, tasks to be performed, etc.), considering the sender of the communication 404, considering the platform through which the communication 404 was received, considering the geographical region from which the communication 404 came, applying one or more rules, referencing a lookup table, running a script, etc.

As illustrated, in some embodiments, reports, dashboards, and/or wallboards 420 may be updated based on the flow of work items 414. For example, reports, dashboards, and/or wallboards 420 may communicate the number of open work items 414, number of work items 414 in a queue 418, time from work item 414 open to closure, time until agent 402 picks up work item 414, and so forth. Further, the reports, dashboards, and/or wallboards 420 may breakdown data by agent 402, agent group, work item type, technology, product/service, channel 406, geographical area, etc.

Typically, routing work items 414 to agent queues 418 has been performed manually by a human being. However, by automating the routing of work items 414 to agent queues 418, routing may be performed more efficiently, with fewer errors, and at lower cost.

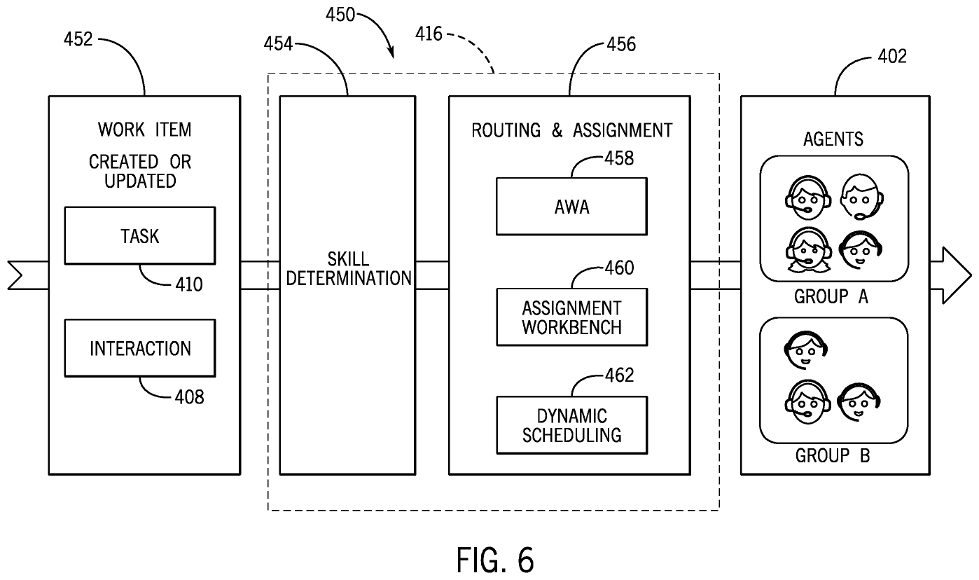

FIG. 6 is a flow chart of a process 450 performed by the routing and assignment system of FIG. 5. At block 452, a work item is created or updated based on a received communication. At block 454, the routing and assignment system identifies one or more skills associated with the work item. Skill determination (block 454) may include applying one or more rules to identify one or skills associated with the work item. In the instant embodiment, rules may fall into one of three categories: simple, dynamic or lookup, and advanced. For simple rules, one or more skills may be determined based on one or more attributes of the work item. For dynamic or lookup rules, the routing and assignment system may reference a lookup table and determine the one or more associated skills based on a relation between a source table and the lookup table. For advanced rules, a script may be run on the work item to determine the skills associated with a work item. At block 456, the routing and assignment system identifies one or more agents 402 possessing the one or more identified skills and adds the work item to their queue. As shown, the routing and assignment block 456 may include steps of Advanced Work Assignment (AWA), use of an assignment workbench, and/or dynamic scheduling 462. In some embodiments, assignment of the work item to an agent may include consideration of the number of items in the agent's queue, the expected amount of time it will take an agent to work through his or her queue, possession of optional skills, degree of proficiency in the identified skills, etc.

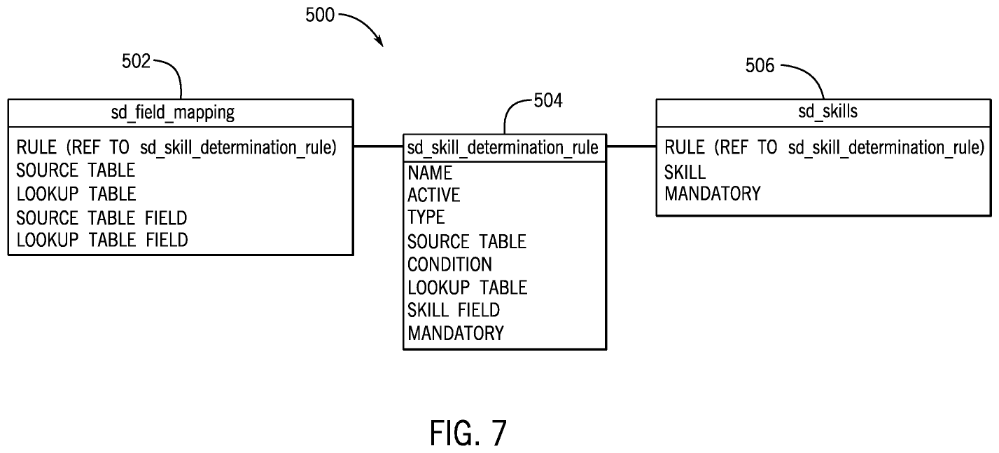

FIG. 7 illustrates an embodiment of a schema 500 of tables used by the routing and assignment system for skill determination. As shown, an sd_field_mapping table 502 identifies a rule, a source table, a lookup table, a source table field, and a lookup table field. The rule field references an sd_skill_determination_rule table 504. The sd_skill_determination_rule table 504 includes fields of name, active, type, source table, condition, lookup table, skill field, mandatory. An sd_skills table 506 includes a rule field, which references the sd_skill_determination_rule table 504, skill, and mandatory. How these tables 502, 504, 506 are utilized is described in more detail below.

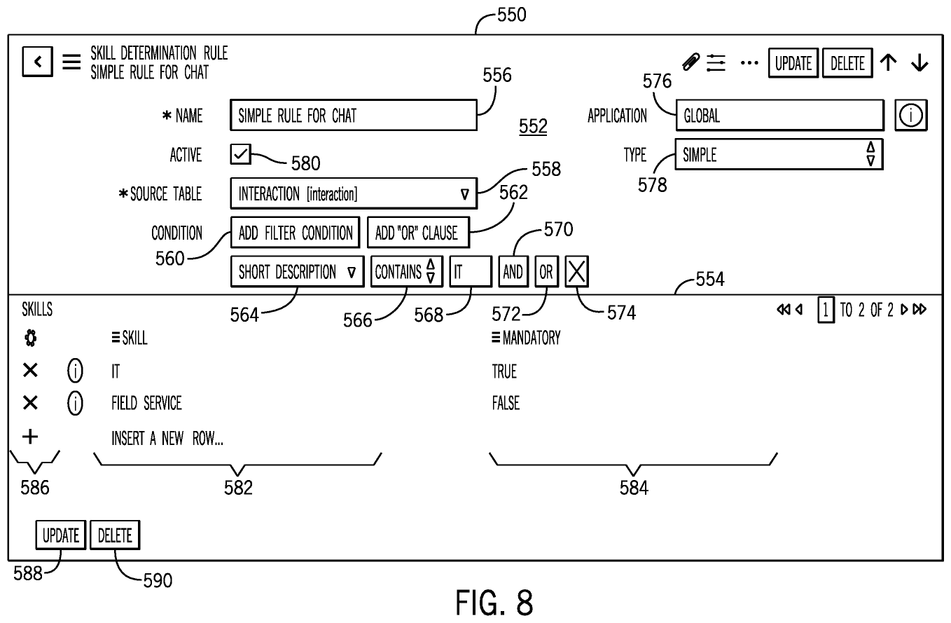

FIGS. 8-11 illustrate user interfaces that may be utilized by a skill administrator to define rules for skill determination. FIG. 8 is a screenshot of an embodiment of a simple rule definition graphical user interface (GUI) 550 for defining a simple rule. As previously described, a simple rule is a rule that determines one or more skills associated with a work item based on an attribute of the work item. As shown, the simple rule definition GUI 550 includes a rule definition window 552 and a skills list 554. The rule definition window 552 allows conditions to be set that define rules. As illustrated, the rule definition window 552 includes a rule name field 556 and a source table field 558. The rule name field 556 may be a fillable text field that is filled in by a user. In the instant embodiment, the rule is called “simple rule for chat”. The source table field 558 identifies the source table for the underlying data.

An add filter condition button 560, add or clause button 562, table field 564, condition field 566, character string field 568, “AND” button 570, “OR” button 572, and delete button 574 may be utilized to define one or more conditions for a simple rule. For example, in the illustrated embodiment, if the text in the “short description” field of the referenced source table (i.e., “Interaction”) contains the character string “IT”, then the condition is met and the simple rule is applied. As shown, the table field 564 may be a drop down menu that displays the various available fields of the source table referenced in the source table field 558. Similarly, the condition field 566 may also include a drop down menu for various options for conditions (e.g., “starts with”, “ends with”, “contains”, “does not contain”, “is”, “is not”, “is empty”, “is not empty”, “matches pattern”, “matches regex”, “is anything”, “is one of”, “is empty string”, “less than or is”, “greater than or is”, “between”, “is same”, “is different”, etc.). The character string field 568 may be a fillable field filled in by a user. Though a single condition is shown, the add filter condition button 560 may be used to add multiple conditions to the rule. These conditions may be related to one another with logic operations (e.g., AND, OR, etc.) such that all of the conditions must be met to trigger the rule, or some subset of the conditions being met triggers the rule. The “AND” button 570 and “OR” button may be used to indicate whether the AND or OR logical operation should be associated with a given condition. Further, the delete button 574 may be used to remove conditions.

The application field 576 may indicate whether the application is globally or locally scoped. The rule type field 578 indicates what type of rule is being defined (e.g., simple, dynamic/lookup, advanced, etc.). As shown, the rule type field 578 may be filled in by selecting an option from a drop down menu. An active checkbox 580 indicates whether or not the rule and/or condition is active and being applied.

Below the rule definition window 552 is the skills list 554. As shown, the skills list 554 includes a list a skills associated with a rule. Each record in the skills list 554 includes fields for the skill name 582 and whether or not the skill is mandatory 584. A mandatory skill is a skill that is required to complete a work item (i.e., a task or interaction). An agent that does not possess a mandatory skill will not be assigned the work item. Correspondingly, an optional skill (i.e., a skill that is not marked as mandatory) is a skill that is optionally required to complete the work item. An agent that does not possess an option skill associate with a work item may still be assigned the work item. The skills list 554 identifies the skills associated with a rule and indicates whether each skill is mandatory or merely suggested when the rule is implemented. For example, in the illustrated embodiment, when the short description field of the referenced lookup table contains the character string “IT”, the IT skill is mandatory, but the field services skill is merely suggested (i.e., not mandatory). As shown, the skills list 554 also includes an edit field 586 allowing a user to add or remove skills from the skills list 554. Further, an update button 588 and a delete button 590 allow a user to edit skills on the skills list 554 and/or remove skills from the skills list 554. Once information has been entered via the simple rule definition GUI 550, the system may use the provided data to generate records in the sd_skill_determination_rule table 504 described with regard to FIG. 7.

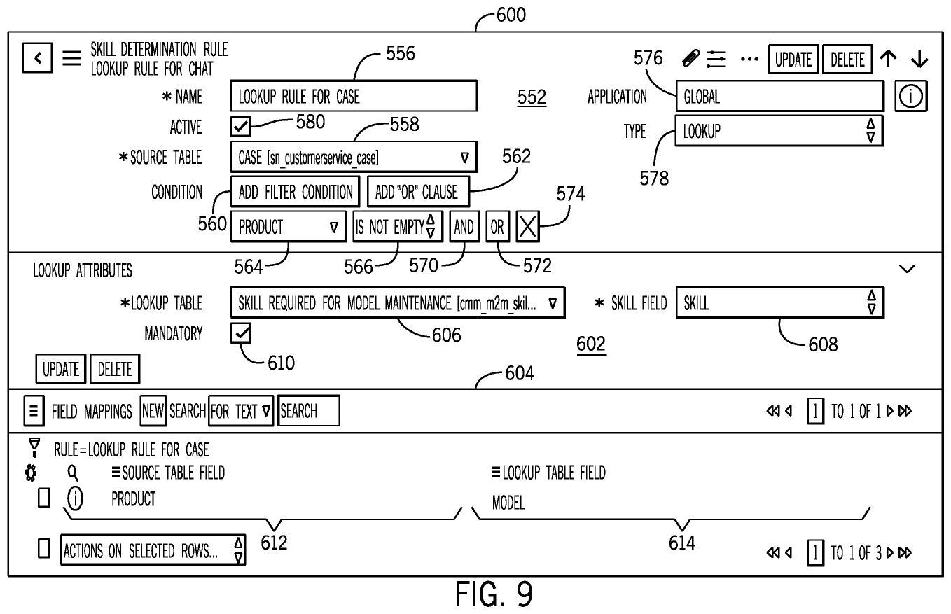

FIG. 9 is a screenshot of an embodiment of a lookup or dynamic rule definition GUI 600 for defining a lookup rule (also referred to as a dynamic rule). As previously described, a lookup rule is a rule that determines one or more skills associated with a work item based on a lookup table and the relation between the lookup table and the source table. As shown, the lookup rule definition GUI 600 includes the rule definition window 552, as well as a lookup attributes window 602 and a field mappings list 604.

As illustrated, the lookup attributes window 602 allows a user to define a lookup table and how the fields of the lookup table correspond to the source table in order to implement the lookup rule. Specifically, the lookup attributes window 602 includes a field for the lookup table 606, a field for the skill field 608 within the lookup table, and a mandatory checkbox 610. As shown, both the lookup table field 606 and the skill field 608 may be selected from drop down menus that are auto-populated based on the available lookup tables and then the field within the selected lookup table. The field mappings list 604 includes one or more records, each record identifying a source table field 612 and a corresponding mapped lookup table field 614. The field mappings list 604 may correspond with the sd_field_mapping table 506 described with regard to FIG. 7. In the instant embodiment, for example, if the product model is identified in the product field of the work item, the model field of the lookup table is referenced. If the model number in the work item corresponds with the model field of the lookup table, the rule identifies the skills associated with maintenance of the identified model.

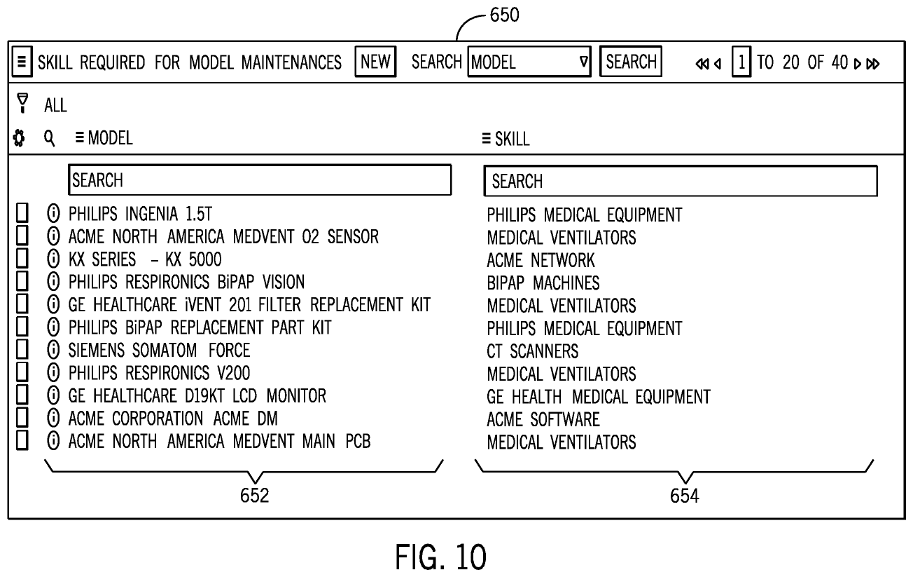

FIG. 10 is a screenshot of an embodiment of the lookup table 650 referenced in FIG. 9. As shown, the lookup table 650 includes a list of records, each identifying a product model 652 and a skill 654 associated with the identified product model.

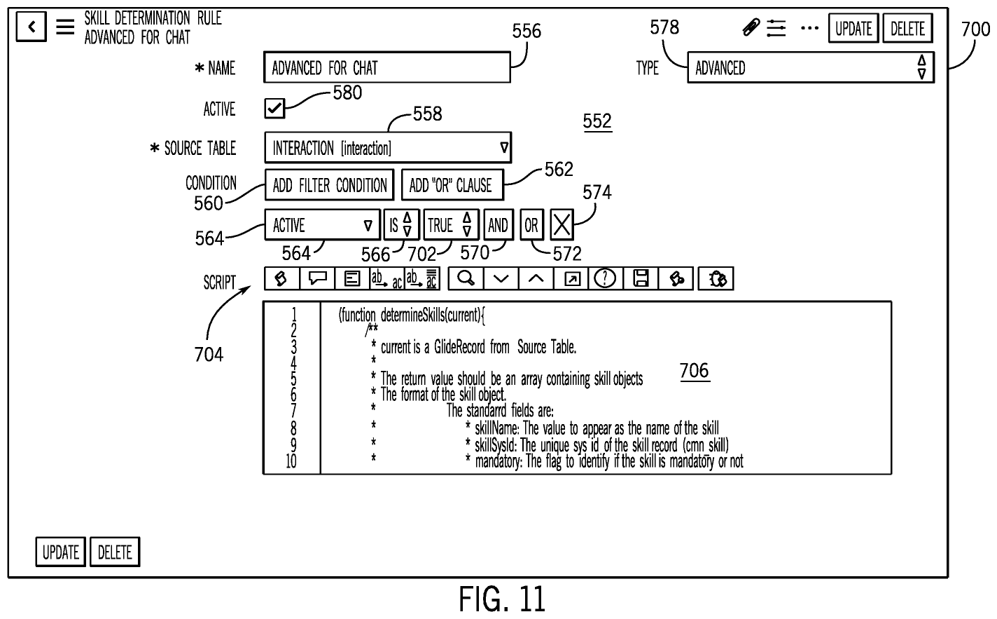

FIG. 11 is a screenshot of an embodiment of an advanced rule definition GUI 700 for defining an advanced rule. As previously described, an advanced rule is a rule that runs a script to determine one or more skills associated with a work item. As shown, the advanced rule definition GUI 700 includes a rule definition window 552, including a rule condition 702, a script toolbar 704, and a script editing window 706. As illustrated in FIG. 11, the script appears within the script window 706. The user may edit the script by moving a cursor and typing within the script window 706. The user may also utilize one or more buttons in the script toolbar 704 to edit the script.

Running the script on a work item, the script may reference the tables identified in FIG. 7 (i.e., the sd_field_mapping table 502, the sd_skill_determination_rule table 504, and/or the sd_skills table 506), as well as other tables (e.g., the source table, a lookup table, etc.) in order to determine skills associated with one or more work items. Further, the script may be able to create, read, update, and delete (CRUD) records within the the sd_field_mapping table 502, the sd_skill_determination_rule table 504, and/or the sd_skills table 506 via a skill admin role. Accordingly, a skill admin may utilize scripts to manage skills rules.

The script may also be utilized to resolve conflicts and/or keep skill mappings up to date. For example, if a skill is no longer required for a work item, the script can be used to remove the associated mapping record. If a new skill is required for a work item, the engine will generate a new mapping record. If a skill is still required for a work item, the script may update the mandatory status of the skill if the mandatory status changes. If there is a conflict between mandatory/optional skills, the script may resolve the conflict (e.g., by giving priority to the mandatory status).

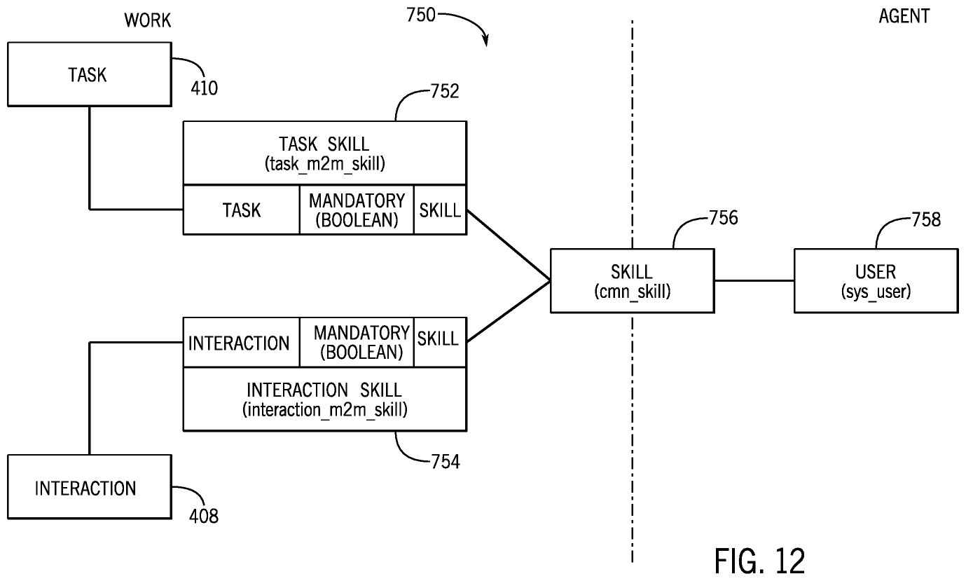

FIG. 12 is a schematic of a skill architecture 750 for skill determination. As shown, one or more work items (e.g., tasks 410 and/or interactions 408) are received. Business rules are then utilized to identify and apply the defined rules (e.g., simple rules, lookup/dynamic rules, and/or advanced rules). Based on the applied rules, many-to-many (m2m) objects 752, 754 are created that associate skills with the received work items 408, 410. A skill table 756 (e.g., cmn_skill) may then be referenced based on the identified skills. A user table 758 (e.g., sts_user) may then be referenced to identify one or more agents possessing the identified skills. In some embodiment, skill possession by agents may be considered in a binary fashion (e.g., agents either have a skill or do not have a skill). However, in other embodiments, skills may have levels or scores that reflect an agent's proficiency at the skill. These may be determined based on agent experience, background, customer survey results, input and/or feedback from supervisors, professional certifications, internal certifications, etc. The work items may then be assigned and/or routed to one or more of the identified agents.

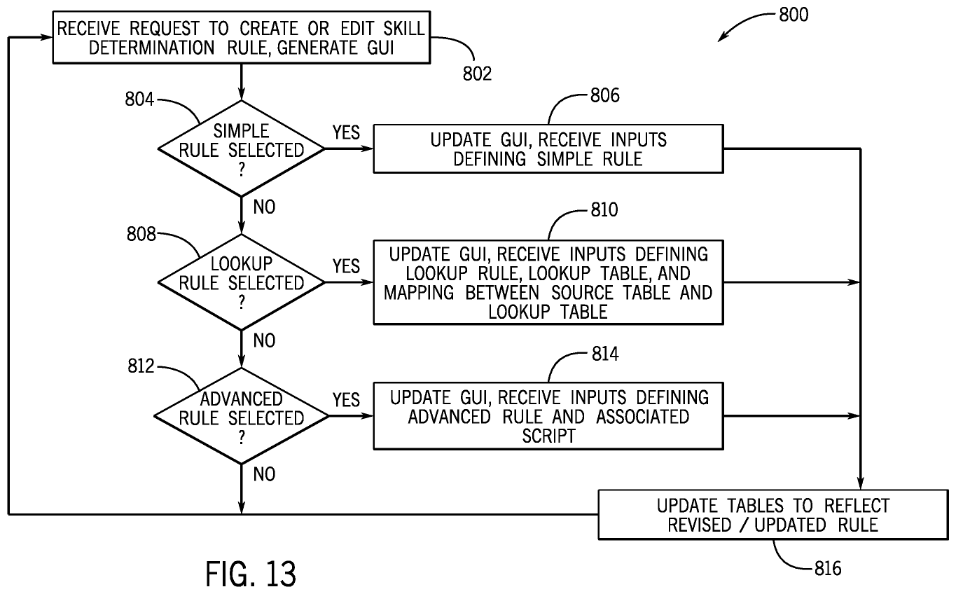

FIG. 13 is a flow chart of a process 800 for defining one or more rules for skill determination of work items. At block 802, a request is received to create or edit a skill determination rule. A GUI for editing an existing rule or defining a new rule may then be generated (e.g., the GUIs shown in and described with regard to FIGS. 8-11). As previously described with regard to FIG. 8, the GUI may include a drop down menu for selecting a type of rule (e.g., simple, lookup/dynamic, or advanced). At decision 804, the process 800 determines whether a simple rule has been selected. If the simple rule has been selected, the process 800 proceeds to block 806 and updates the GUI for defining a simple rule (e.g., as shown in FIG. 8) and receives inputs defining a simple rule.

If a simple rule has not been selected, the process 800 proceeds to block 808 and determines whether a lookup rule has been selected. If a lookup rule has been selected, the process 800 proceeds to block 810 and updates the GUI for defining a lookup rule (e.g., as shown in FIG. 9) and receives input defining the lookup rule, which may include a lookup table, and mappings between fields of the lookup table and the source table.

If a lookup rule has not been selected, the process 800 proceeds to block 812 and determines whether an advanced rule has been selected. If an advanced rule has been selected, the process 800 proceeds to block 814 and updates the GUI for defining an advanced rule (e.g., as shown in FIG. 11) and receives input defining the advanced rule, which may include an associated script. At block 816, one or more tables (e.g., the sd_field_mapping table 502, the sd_skill_determination_rule table 504, and/or the sd_skills table 506) may be updated to reflect the new or updated rule.

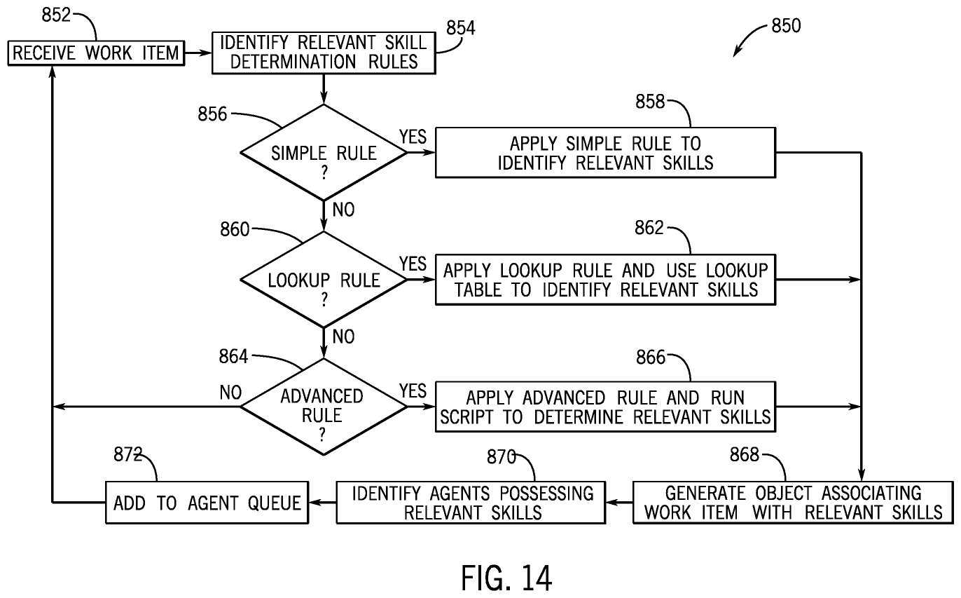

FIG. 14 is a flow chart of a process 850 for receiving a work item and identifying the skills associated with the work item. At block 852, a work item is received. At block 854 the process identifies the relevant skill determination rules. This may include, for example, running through a plurality of conditions and determining whether the conditions are true or not based on the work item. At decision 856, the process 850 determines if the identified relevant skills include a simple rule. If yes, the process 850 proceeds to block 858 and applies the simple rule to identify the relevant skills associated with the work item.

If the identified relevant skills do not include a simple rule, the process 850 proceeds to block 860 and determines whether the identified rules include a lookup rule. If yes, the process 850 proceeds to block 862 and applies the lookup rule and uses the lookup table to identify the relevant skills associated with the work item.

If the identified relevant skills do not include a lookup rule, the process 850 proceeds to block 864 and determines whether the identified rules include an advanced rule. If yes, the process 850 proceeds to block 866 and applies the advanced rule and uses the script table to identify the relevant skills associated with the work item.

At block 868, the process 850 generates an object associating the received work item with the relevant skills identified in blocks 858, 862, and/or 866. At block 870, one or more agents possessing the relevant skills are identified. At block 872, the work item is added to a queue of the one or more identified agents.

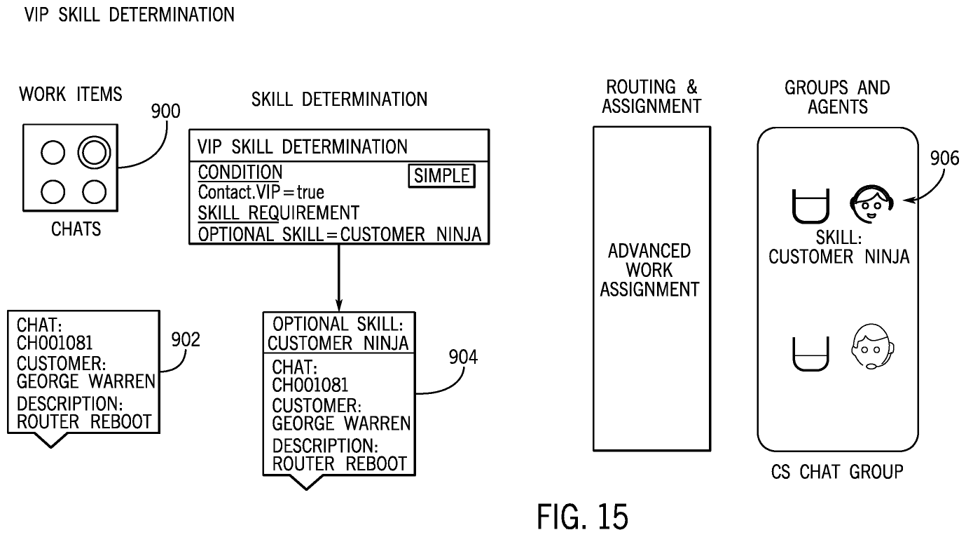

FIG. 15 illustrates an example of utilizing the disclosed techniques to apply a simple VIP skill determination rule. As illustrated, a work item 900 is received from a customer named George Warren in the form of a chat message 902 regarding a router reboot. The system notes that George Warren is a VIP customer (e.g., Contact.VIP=true), and applies a rule to determine that the skill “customer ninja” is optionally required, so an m2m object 904 is created for the work item 900 identifying “customer ninja” as an optionally required skill. The work item 900 is then routed to an agent 906 possessing the “customer ninja” skill.

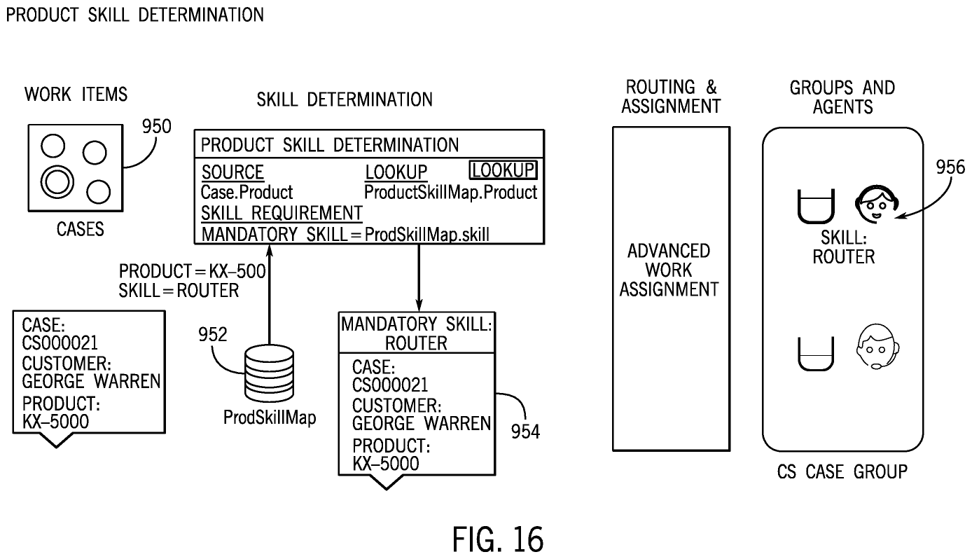

FIG. 16 illustrates an example of utilizing the disclosed techniques to apply a lookup product skill determination rule. As illustrated, a work item 950 is received for the customer George Warren regarding his router. The system identifies a product in the work item and references a lookup table or database 952 for the identified product to identify “router” as a mandatory skill. An m2m object 954 is created for the work item 950 identifying “router” as a mandatory skill. The work item 950 is then routed to an agent 956 possessing the “router” skill.

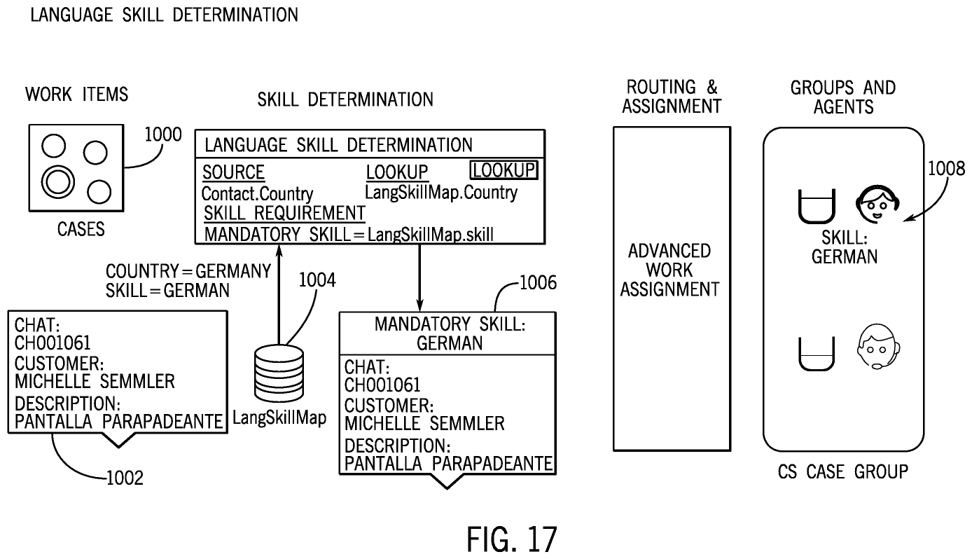

FIG. 17 illustrates an example of utilizing the disclosed techniques to apply a lookup language skill determination rule. As illustrated, a work item 1000 is received via a chat message 1002 from a customer named Michelle Semmler. The system identifies that the customer is located in Germany and references a lookup table or database 1004 for the contact country to identify “German” as a mandatory skill. An m2m object 1006 is created for the work item 1000 identifying “German” as a mandatory skill. The work item 1000 is then routed to an agent 1008 possessing the “German” skill.

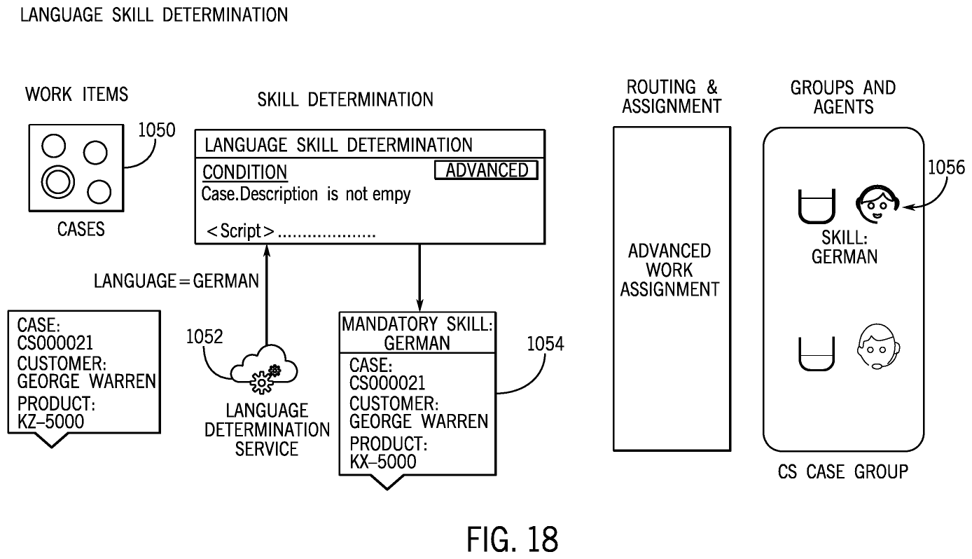

FIG. 18 illustrates an example of utilizing the disclosed techniques to apply an advanced language skill determination rule. As illustrated, a work item 1050 is received for the customer George Warren regarding his router. The system runs a script that, based on the description not being empty, utilizes a language determination service 1052 to identify the language used in the case description as German and subsequently identifies “German” as a mandatory skill. An m2m object 1054 is created for the work item 1050 identifying “German” as a mandatory skill. The work item 1050 is then routed to an agent 1056 possessing the “German” skill.

The disclosed techniques relate to defining skill determination rules and then using the skill determination rules to identify skills associated with work items. Upon receipt of a request to create a new skill determination rule or edit an existing skill determination rule, a skill determination rule definition GUI is generated and displayed and a type of skill determination rule may be selected. A simple rule may identify skills associated with the work item based on an attribute of the work item. A lookup or dynamic rule may identify skills associated with the work item by referencing a lookup table and mapping a field of the lookup table to a field of a source table. An advanced rule may identify skills associated with the work item by running a script. Dependent upon the type of rule selected, the user may provide inputs defining a rule of the selected type.

Once skill determination rules are defined, upon receipt of a work item, the relevant skill determination rules may be identified and applied. If the relevant skill determination rule is a simple rule, the relevant skills may be identified based on an attribute of the work item. If the relevant skill determination rule is a lookup or dynamic rule, the relevant skills may be identified by referencing a lookup table and mapping a field of the lookup table to a field of a source table. If the relevant skill determination rule is an advanced rule, the relevant skills may be identified by running a script on the work item. Once the relevant skills are identified, a many-to-many (m2m) object may be generated associating the work item with the relevant skills. Agents possessing the identified skills may be identified. If multiple agents are identified, an agent may be selected and the work item added to the selected agent's queue.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A system, comprising:
a processor; and
a memory, the memory storing instructions that, when executed by the processor, cause the processor to:
receive a work item;
apply one or more skill determination rules to identify one or more skills associated with the work item;
generate an object associating the work item with the one or more identified skills;
identify an agent possessing the one or more identified skills; and
add the work item to the agent's queue.

2. The system of claim 1, wherein the one or more skill determination rules comprise one or more simple rules, wherein the one or more skills associated with the work item are identified based on an attribute of the work item.

3. The system of claim 1, wherein the one or more skill determination rules comprise one or more lookup rules, wherein the one or more skills associated with the work item are identified by referencing a lookup table and mapping a field of the lookup table to a field of a source table.

4. The system of claim 1, wherein the one or more skill determination rules comprise one or more advanced rules, wherein the one or more skills associated with the work item are identified by running a script.

5. The system of claim 1, wherein the work item comprises a task or an interaction.

6. The system of claim 1, wherein the object comprises a many-to-many (m2m) object.

7. The system of claim 1, wherein the instructions, when executed by the processor, cause the processor to: select the one or more skill determination rules from a plurality of skill determination rules based on one or more attributes of the work item.

8. The system of claim 1, wherein the one or more skills comprise a mandatory skill, an optional skill, or both.

9. A method, comprising:
receiving a work item, wherein the work item comprises a task or an interaction;
applying one or more skill determination rules to identify one or more skills associated with the work item, wherein the one or more skills comprise a mandatory skill, an optional skill, or both;
generating a many-to-many (m2m) object associating the work item with the one or more identified skills;
identify an agent possessing the one or more identified skills; and
add the work item to the agent's queue.

10. The method of claim 9, wherein the one or more skill determination rules comprise one or more simple rules, wherein the one or more skills associated with the work item are identified based on an attribute of the work item.

11. The method of claim 9, wherein the one or more skill determination rules comprise one or more lookup rules, wherein the one or more skills associated with the work item are identified by referencing a lookup table and mapping a field of the lookup table to a field of a source table.

12. The method of claim 11, wherein the lookup table identifies one or more products, one or more services, or both.

13. The method of claim 9, wherein the one or more skill determination rules comprise one or more advanced rules, wherein the one or more skills associated with the work item are identified by running a script.

14. The method of claim 9, comprising selecting the one or more skill determination rules from a plurality of skill determination rules based on one or more attributes of the work item.

15. The method of claim 9, comprising selecting the agent possessing the one or more identified skills from a plurality of agents possessing the one or more identified skills based on a number of item's in the agent's queue.

16. A system, comprising:
a processor; and
a memory, the memory storing instructions that, when executed by the processor, cause the processor to:
receive a request to create a skill determination rule;
generating a graphical user interface (GUI) configured to receive inputs defining the skill determination rule;
receive an input specifying a rule type of the skill determination rule;
update the GUI for the specified rule type;
receiving a set of inputs defining a skill determination rule to identify one or more skills associated with a work item; and
updating one or more tables to reflect the skill determination rule.

17. The system of claim 16, wherein the skill determination rule comprises a simple rule, wherein the one or more skills associated with the work item are identified based on an attribute of the work item.

18. The system of claim 16, wherein the skill determination rule comprises a lookup rule, wherein the one or more skills associated with the work item are identified by referencing a lookup table and mapping a field of the lookup table to a field of a source table.

19. The system of claim 16, wherein the skill determination rule comprises an advanced rule, wherein the one or more skills associated with the work item are identified by running a script.

20. The system of claim 16, wherein the one or more skills comprise a mandatory skill, an optional skill, or both.
